(19) United States
(12) Patent Application Publication
(10) Pub. No.: US 2017/0066588 A1
(43) Pub. Date: Mar. 9, 2017

(54) BICYCLE TRANSPORT CONTAINER AND BICYCLE FIXING ELEMENT

(71) Applicant: Canyon Bicycles GmbH, Koblenz (DE)

(72) Inventors: David Schreiber, Eitelborn (DE); Christian Hass, Neuwied (DE)

(21) Appl. No.: 14/883,831

(22) Filed: Oct. 15, 2015

(30) Foreign Application Priority Data
Sep. 5, 2015 (DE) 202015006608.9

(51) Int. Cl. B65D 85/68; B62K 15/00; F16B 1/00; B65D 25/10; F16B 2/08

(52) U.S. Cl. CPC B65D 85/68; B65D 25/10; F16B 2/08; F16B 1/00; B62K 15/00; B65D 2585/6862; F16B 2001/0028; B62K 2015/001

(57) ABSTRACT

An outer container of a bicycle transport container is adapted to transport a pre-assembled bicycle in it. The bicycle frame is already connected to the rear wheel, the fork and the stem. The front wheel, the handlebar and the saddle are connected to the frame and respectively the fork via fixing elements. For positionally correct arrangement of such a bicycle prepared for transport, outer container is provided with rear-stay receiving portions, a stem receiving portion and a spacer element

### BACKGROUND

1. Field of the Disclosure

The present disclosure relates to bicycle transport containers and a bicycle fixing element.

2. Discussion of the Background Art

A transport cardboard box for bicycles is known from EP 1 849 717. The bicycle transport box described therein comprises a parallelepipedic outer box. In the outer box, a frame fixing element is arranged which extends along the full length of the box and is supported on the bottom of the box. The frame fixing element comprises two web elements of a V-shaped cross section, each comprising a bottom bracket recess serving as a bottom bracket receiving portion. Thus, the bicycle frame can be inserted from above into the frame fixing element so that the bicycle frame is held in the bottom bracket receiving portion at the bottom bracket. Further known from EP 1 849 717 is a wheel storage box wherein a disk-shaped element, likewise made of cardboard, is arranged on each side of the wheel. The respective wheel boxes can be arranged in the outer box of the bicycle transport box together with the bicycle frame.

The bicycle transport box described in EP 1 849 717 is particularly suited for shipment of bicycles by parcel delivery services. For economical reasons, the box is desired to have the smallest possible outer dimensions when shipped this way. Further, the transport boy should have high stability so as to avoid damage to the bicycle frame. In practical use of the transport box described in EP 1 849 717, occasional transport damage has been found to occur in spite of the high stability of the box.

A more advanced bicycle transport box is described in EP 2 239 210. This box again comprises an outer box which herein has a rear-stay receiving portion and a fork receiving portion arranged in it. Said rear-stay receiving portion and said fork receiving portion are arranged inside the transport box on the lower side or bottom of the box. The bicycle frame will then be inserted from above into the rear-stay receiving portion and respectively the fork receiving portion. To make it possible to use the same outer box for different frame sizes, the stay receiving portion and/or the fork receiving portion are provided with a spacer element which is adjustable in length. Said spacer element is arranged in abutment on an inner side of a side wall of the outer box. Depending on the length of the spacer element, it is thus possible to set the distance between the stay receiving portion and the fork receiving portion for adjustment to different frame sizes. Using a bicycle transport box of this type, transport damage to the bicycle can be avoided. It is also possible to select the outer dimensions of this box in such a manner that the maximum combined length and girth measure as required by parcel delivery services will not be exceeded. However, such a bicycle transport box has the disadvantage that the customer will later have to mount both the rear wheel and the front wheel. Further, during the packaging process, the risk exists that the derailleur arranged on the dropout end of the rear stay might be damaged.

It is an object of the disclosure to provide an improved bicycle box which is suited for shipment by parcel delivery services.

### SUMMARY

The preferably parallelepipedic bicycle transport container of the disclosure, which preferably is a bicycle transport box made of cardboard, comprises an outer container, preferably an outer cardboard box. The outer container serves for accommodating a bicycle and is preferably suited to accommodate all of the components of the bicycle.

In the first disclosure, related to the bicycle transport container, a bicycle can be arranged in the outer box while the rear wheel is allowed to remain in the mounted state. This has the advantage that, in the packaging process, damage to the derailleur arranged on a dropout end of the rear stay will be avoided. For this purpose, a lower rear wheel receiving portion as well as an upper rear wheel receiving portion are arranged within the outer box. The lower rear wheel receiving portion is preferably arranged on the bottom of the outer box. In the packed state, the upper rear wheel receiving portion is arranged opposite to the lower rear wheel receiving portion.

According to a preferred embodiment, there is further provided a stabilizing element. This element is at least partially arranged between the upper and the lower rear wheel receiving portions and thus forms a connection between the two rear wheel receiving portions, wherein this does not need to be a fixed connection. Particularly, the stabilizing element at least partially covers one of the two rear wheel receiving portions when seen in lateral view and/or is inserted into it/them. With particular preference, the stabilizing element is formed as a small-parts container. The stabilizing element, which in this case is preferably designed as a box, will thus have a dual function by serving, in addition to its stabilizing function, also for storage of small-parts. Small parts in this regard can be e.g. assembly instructions, pedals, tools or the like. Provision of such a stabilizing element is optional. Particularly in the special embodiment described hereunder, the provision and arrangement of an upper and a lower rear wheel receiving portion constitutes an disclosure in its own right.

Preferably, the lower and/or the upper rear wheel receiving portion comprise a lateral element which in the packed state is in abutment on an inner side of a side wall of the outer container. In this arrangement, a face-to-face abutment is preferred. Achieved thereby is a defined position within the box relative to the two rear wheel receiving portions in the longitudinal direction. Further, it is preferred that the lateral element of the lower and/or upper rear wheel receiving portion have a width substantially corresponding to the width of the inner side of the inner wall of the outer container. In this manner, there is defined the lateral position of the lower and/or the upper rear wheel receiving portion in the outer container.

According to a further preferred embodiment, the upper and/or the lower rear wheel receiving portion comprise an outer element. In the assembled state, the outer element of the lower rear wheel receiving portion is preferably in abutment on a bottom. In an upper rear wheel receiving portion with outer element, the rear wheel receiving portion will in the assembled state be in abutment on an inner side of the cover of the outer container. With respect to the outer element, a face-to-face abutment is preferable again. The width of the outer element of the lower and/or upper rear wheel receiving portion is preferably selected to correspond to the width of the inner side of the bottom and respectively cover of the outer container. In this manner, a lateral guidance is guaranteed.

According to a further preferred embodiment of the lower and/or the upper rear wheel receiving portion, the lateral element is arranged at an angle of 90° relative to the outer element. This makes it possible particularly that, at the same time, the lateral element is in face-to-face abutment on an inner side of the outer container and the outer element is in abutment on an inner side of the bottom and respectively cover of the outer container.

Preferably, the lateral element is connected to the outer element via a connection element wherein this again is preferably the case both for the lower and for the upper rear wheel receiving portion. The connection is preferably realized in such a manner that, when seen in lateral view, the lateral element, the outer element and the connection element are substantially of a triangular configuration.

Preferably, the connection element of the lower and/or the upper rear wheel receiving portion comprises a slot for receiving a part of the rear wheel. The width of the slot is preferably selected to correspond to a width of a bicycle tire.

According to a particularly preferred embodiment of the lower and/or the upper rear wheel receiving portion, the lateral element and/or the outer element and/or the connection element are, on their outer sides, preferably formed in a flat shape adjacent to the box. It is particularly preferred that these elements are made of an element of the box itself. In this regard, it is preferred that the lower and/or the upper rear wheel receiving portion are produced by cutting and kinking a flat cardboard element and fitting the resultant portions to each other in a corresponding manner.

In a preferred embodiment, the lower rear wheel receiving portion and the upper rear wheel receiving portion are formed to have identical configurations. Since the two rear wheel receiving portions are arranged in the outer box in different positions, the two rear wheel receiving portions are, in the packaged state of the bicycle, arranged opposite to each other and are preferably configured in mirror symmetry relative to the horizontal plane. The identical design of the two rear wheel receiving portions allows for lower production costs and for easier handling because, during the packaging process, no mix-up of the two receiving portions will be possible.

According to a particularly preferred embodiment, a stabilizing element is provided in addition to the two rear wheel receiving portions. The stabilizing element is at least partially arranged between the two rear wheel receiving portions and is preferably designed as a small-parts container. Preferably, the stabilizing element has a length slightly less than the inner height of the outer box. In connection with the thickness of the two outer elements of the two rear wheel receiving portions, this substantially corresponds to the entire inner dimension of the outer container. This makes it possible to achieve a good stabilizing effect.

According to preferred embodiment, the lower and/or the upper rear wheel receiving portion comprise a recess having a part of the stabilizing element extending into it. Preferably, this recess is provided in the connection element of the lower and/or upper rear wheel receiving portions.

A further independent disclosure relates to a bicycle transport container, particularly a bicycle transport box made of cardboard, which again comprises an outer container, particularly an outer box made of cardboard. Said bicycle transport container serves for receiving a bicycle, preferably with the stem in its mounted state and with the front-wheel fork in its mounted state. According to a preferred embodiment of this bicycle transport container, this container is combined with the above described bicycle transport container so that the bicycle transport container is adapted to receive a bicycle while both the rear wheel and the stem with the front-wheel fork are in their mounted states.

The bicycle transport container according to this further disclosure wherein at least the stem is partially mounted in the frame, preferably together with the front-wheel fork, comprises a stem receiving portion. The stem receiving portion serves for holding the stem in its position in the outer box. Thus, since the stem is connected to the frame particularly via the fork shaft of the bicycle fork, also the bicycle frame will be fixed in the outer box in this area.

Preferably, the stem receiving portion comprises a holding element at least partially gripping around the stem. Said holding element can be a band, a hook- and loop fastener or the like. Preferably, the holding element is arranged to be at least located laterally of the stem. The stem receiving portion is realized e.g. in the form of cardboard walls which are at least partially arranged laterally of the stem. This has the advantage that, during the packaging process, said walls can be easily arranged in this position and there is no need for a tight fixation on the stem e.g. by a hook-and-loop band. Thereby, packaging is facilitated. Further, it is preferred that the holding element encloses the stem on its sides completely. Preferably, the holding element this comprises four holding members which preferably are formed as cardboard walls. These surround the stem in the manner of a frame and respectively represent side walls of a cuboid. This cuboid is preferably downwardly open in the direction toward the bicycle frame so that the holding element, preferably comprising four holding members, can be mounted from above onto the stem.

Further, it is preferred that the stem receiving portion comprises a positioning element for defining the position of the stem receiving portion in the outer box. The positioning element is preferably connected to the holding element or can be formed in one piece therewith. The positioning element can be realized e.g. in the form of web-shaped projections connected to the holding element, or the like. These have such a length and respectively such outer dimensions that the positioning element can be arranged within the outer box in a manner causing the outer sides of the positioning element to contact the sides of the outer box. Achieved thereby is a—particularly lateral—positional definition of the stem receiving portion. It is particularly preferred that the positioning element has a width substantially corresponding to the clear width of the outer box. Particularly, the positioning element can be made of cardboard wherein, according to a particularly preferred embodiment, this will be rectangular cardboard plate. In this case, the preferably parallelepipedic holding member is preferably fixed on an underside of this plate. Thus, for packaging the bicycle, the holding receiving portion can be easily placed from above onto the stem which is already arranged within the outer box, thereby automatically effecting a lateral fixing of the stem by the holding element and a defined position of the stem receiving portion due to the positioning element.

According to a further preferred embodiment, a support element for a mounted front-wheel fork is provided on the bottom of the outer box. This support element preferably is an element made of cardboard that is sunk into the outer box. However, the support element can also be realized as a thickened portion of the outer box that is generated e.g. by a corresponding multi-layered folded configuration of the outer box in this area. According to a preferred embodiment, the support element comprises two recesses wherein, in each of these recesses, a fork-leg end and respectively a drop-out end of the mounted fork will be arranged. Such a support element does not only safeguard that damage to the fork-leg ends during transport is prevented but, because of the arrangement of the fork ends in the recesses, it will also effect a lateral positional fixing.

With particular preference, the two above described disclosures related to the rear wheel receiving portion and to the stem and/or fork-leg receiving portion are combined with each other. Thereby, it is rendered possible that a largely pre-assembled bicycle can be arranged in a very effective manner within a bicycle transport box wherein the danger of transport damage is considerably reduced.

A further independent disclosure resides in a fixing element provided to connect bicycle components for transportation. Said fixing elements is suited particularly for fixing a front wheel, a handlebar, a saddle or the like to the bicycle frame or to a bicycle wheel fork. By the fixing element, a fixed connection of the individual bicycle components is effected. The fixing element comprises a protective body which is arranged between the bicycle components to be connected. Further, the fixing element comprises a connection element provided to hold the protective body particularly in its position between the two to-be-connected bicycle components and, at the same time, to connect the bicycle components to each other. Thereby, due to the provision of the protective body, damage during transport will be avoided and, due to the provision of the connection element, a safe, tight connection between the bicycle components will be guaranteed, thus preventing bicycle components from sliding out of position with resultant damage.

The protective body preferably is an elastomeric body. Preferably, the protective body is a parallelepipedic body. This has the advantage that the corresponding protected body can be arranged at different sites between the to-be-connected bicycle components. However, it is also possible to provide specially shaped protective bodies for arrangement at specific positions.

The connection element is preferably band-shaped and/or comprises a hook-and-loop fastener and/or a similar element. In this respect, it is particularly preferable that the band-shaped connection element comprises a hook-and-loop fastener arranged on both sides so that the connection element can be easily attached in different positions.

Preferably, the protective body comprises a slot having the connection element extending through it. Preferably, thus, one end of the connection element is fixedly connected to the protective body so that, e.g. after winding the connection element around the two to-be-connected bicycle components, the second end of the connection element can again be connected to the protective body or, on the other hand, to the connection element itself.

According to a preferred embodiment, the protective body comprises a laterally open recess. This has the advantage that the connection element can be arranged in said recess while being in its connected position, so that the connection element cannot slide out of place during transport.

The fixing element of the disclosure particularly has the advantage that individual bicycle components can be fixedly arranged on the bicycle frame or on the bicycle fork. Particularly, it is possible to prepare a bicycle for packaging and then to arrange it in one of the above described bicycle transport containers of various designs. In such an arrangement, the bicycle frame has e.g. a front wheel fixedly connected to it by means of the above described fixing elements. In this regard, according to a preferred embodiment, the connection to the front wheel can be realized in that a support point for the front wheel is arranged on the bottom of the bicycle transport container below an underside of the chain ring so that the chain ring will be protected from damage during transport.

According to a further embodiment related to a bicycle prepared for packaging, the handlebar is further connected by means of the above described fixing elements to the bicycle frame and/or a bicycle fork. According to a further embodiment, this also holds true for the saddle. Further, it is preferred that the bicycle provided for packaging is pre-assembled to the effect that particularly the rear wheel and also the fork with the stem will have been mounted already. This has the advantage that, subsequent to transportation, the customer can assemble the bicycle in a few steps.

A bicycle provided to be packaged and comprising components fixed to the bicycle frame or the bicycle fork represents a unit. This unit can be easily inserted from above, via a narrow side, into the bicycle transport container so that, afterwards, it will merely be required to fix the bicycle in the transport container and the transport container can then be closed. It will not be necessary to separately fix individual components within the bicycle transport container.

The bicycle transport container for a bicycle with mounted rear wheel constitutes an disclosure in its own right. In this disclosure, the other components could also be arranged or fixed in the box separately. Fixation of the frame in the front area could also be performed with the aid of foam cushions or the like. Also the bicycle transport container for transport of a bicycle with pre-mounted stem and fork constitutes an disclosure in its own right. Also here, the other components such as e.g. the front wheel and the rear wheel, can be arranged in the box separately and be fixed in a separate manner. Again, fixation can be performed by foam cushions, air cushion pads or the like. A third disclosure resides in the provision of fixing elements for connection of bicycle components for transport.

Particularly preferred is a combination of individual ones of these disclosures and particularly of all of them.

### BRIEF DESCRIPTION OF THE DRAWINGS

A full and enabling disclosure of the present disclosure, including the best mode thereof, enabling one of ordinary skill in the art to carry out the disclosure, is set forth in greater detail in the following description, including reference to the accompanying drawing in which

FIG. 1 is a schematic lateral view of the bicycle transport container with a packaged bicycle wherein, for clear representation of the details, the lateral wall of the outer container is not illustrated,

FIG. 2 is a schematic lateral view of a rear wheel receiving portion.

FIG. 3 is a schematic front view of a rear wheel receiving portion as seen in the direction of arrow III in FIG. 2,

FIG. 4 is a schematic plan view of a rear wheel receiving portion in the non-folded state,

FIG. 5 is a schematic view of a stem receiving portion from below,

FIG. 6 is a schematic plan view of a fixing element,

FIG. 7 is a schematic lateral view of a fixing element, and

FIG. 8 is a view of an example of the fixation of a front wheel to a frame tube with the aid of the fixing element shown in FIGS. 6 and 7.

### DETAILED DESCRIPTION OF PREFERRED EMBODIMENTS

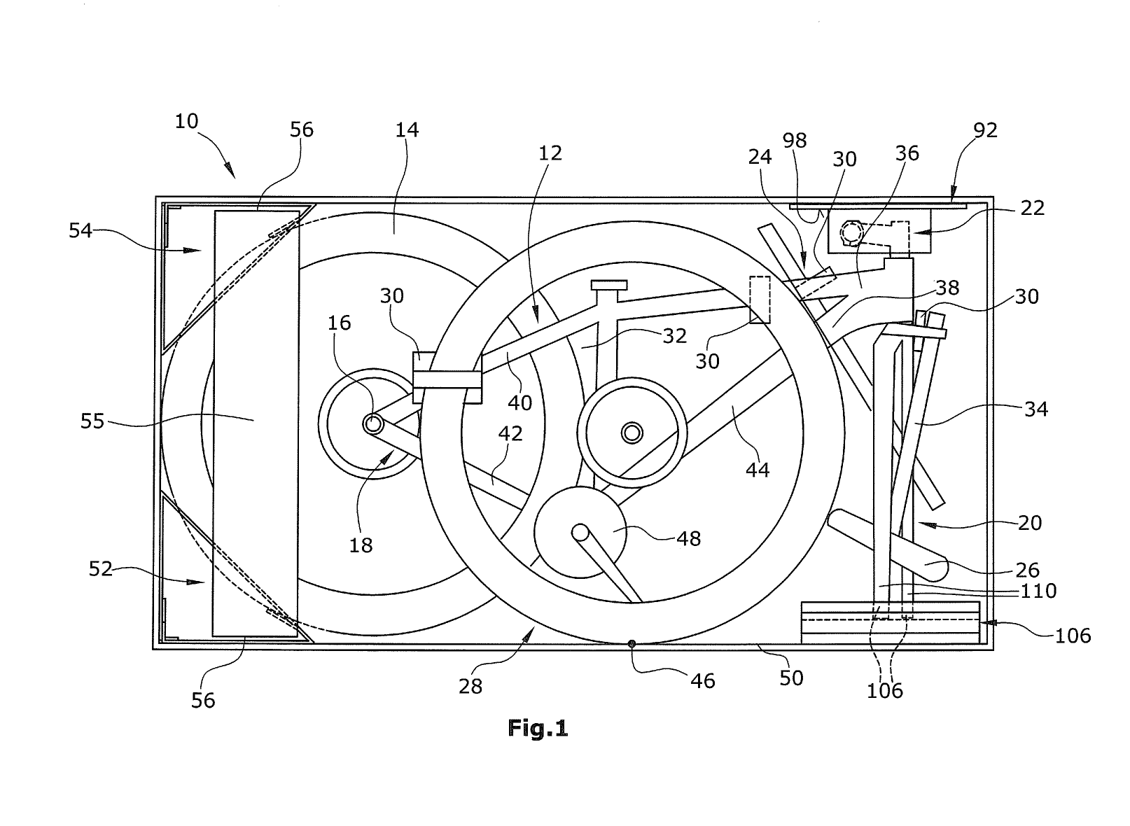

In FIG. 1, there is schematically illustrated a bicycle arranged in a bicycle transport container such as bicycle transport box 10 made of cardboard. The front side of the box is not illustrated herein so as to offer an unobstructed view onto the arrangement of the bicycle within the bicycle transport box 10. Within box 10, a bicycle frame 12 is arranged with a rear wheel 14 in its mounted state, i.e. with a hub 16 of rear wheel 14 mounted on dropout ends of a rear stay 18. Further, a bicycle fork 20 and a stem 22 are already fully mounted. Not mounted are a handlebar 24, a saddle 26 and a front wheel 28. In the illustrated embodiment, the saddle 26 is connected, via a fixing element 30, to the fork 20, particularly at a fork bridge. The saddle 26 can also be connected e.g. to a saddle support tube 32. This is the case particularly if, with a saddle that is mechanically adjustable in height, a wire rope is guided from a saddle tube 34 into the saddle support tube 32. The handlebar 24 is likewise fixed via a fixing element 30 to an upper tube 36 of the frame. A further fixation can be provided e.g. at a lower tube 38.

In the illustrated embodiment, the front wheel is arranged in front of frame 12. The front wheel is fixedly connected to the frame via two fixing elements 30. In the illustrated embodiment, the fixation is provided at the upper tube 36 and at a seat stay 40 of the rear sub-frame 12. An additional or alternative fixation can also be provided at a chain stay 42 of rear stay 18 and/or at a down tube. According to a preferred embodiment, the fixation of the front wheel 28 to the frame is performed in such a manner that, in the fixed state, a lower point 46 of the front wheel is arranged below a chain ring 48. Thereby, it is safeguarded that the lower point 46 of the front wheel will form a support point on an inner side of a bottom 50 of the bicycle box 10 and, due to the fixation of front wheel 28 to frame 12, the chain ring 48 is held at a distance from the bottom. In this manner, damage to the chain ring is avoided. In this regard, it is an independent disclosure that a fixation of the front wheel 28 to the frame is provided to the effect that, for transport, the lower point 46 of the front wheel is arranged lower than an underside of the chain ring. Thus, a distance exists between the lowermost point 46 of the front wheel 46 of the front wheel and an underside of the chain ring 48.

A further fixation of the bicycle in transport box 10 is realized via rear wheel 14 mounted on rear stay 18. For this purpose, there are arranged, within the bicycle box and respectively the outer box 10 enclosing the partially pre-assembled bicycle, a lower rear wheel receiving portion 52 and an upper rear wheel receiving portion 54. According to a preferred embodiment, the two rear wheel receiving portions 52,54 are of identical configurations. At least partially between the two rear wheel receiving portions 52,54, a small-parts box 55 is arranged as a stabilizing element. This box is a preferably parallelepipedic cardboard box having a height slightly less than the height of outer box 10. Together with the outer elements 56 of the two rear wheel receiving portions 52,54 which also have a certain thickness, this corresponds to the overall height of the inner height of box 10. Realized thereby is a stable, fixed and secure accommodation of the rear wheel in the outer box 10.

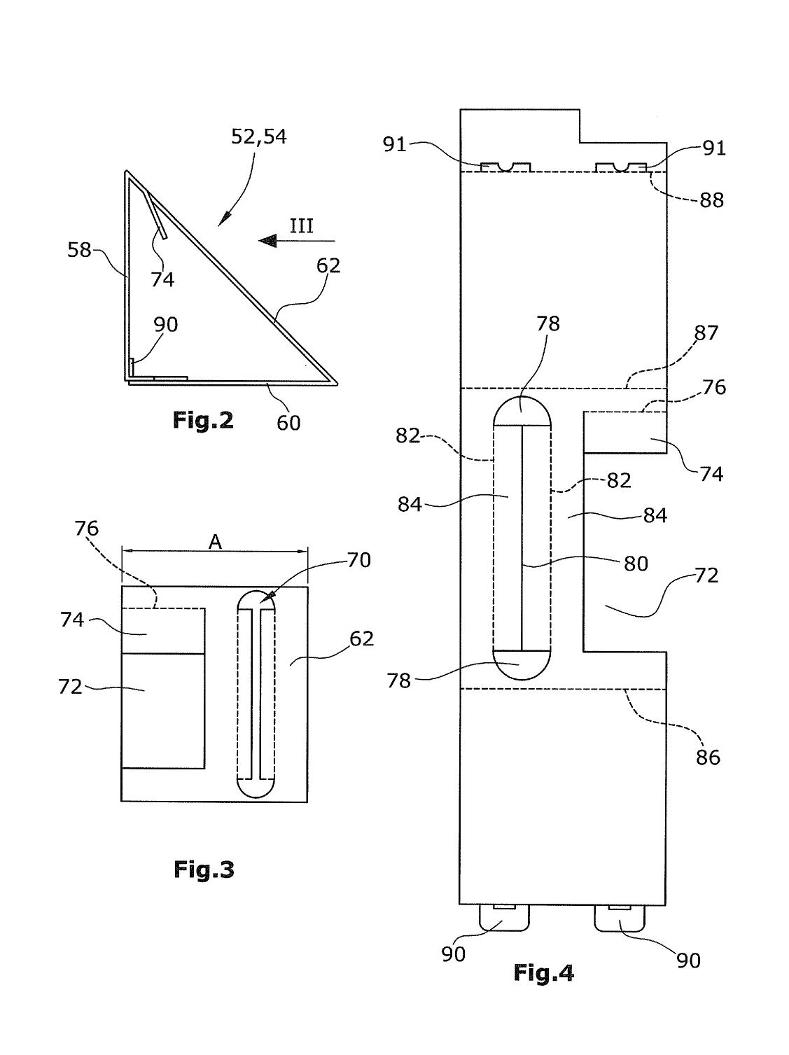

Hereunder, the upper and the lower rear wheel receiving portion 52 and respectively 54 will be described with reference to FIGS. 2-4 wherein, in the illustrated exemplary embodiment, the two rear wheel receiving portions 52,54 are of an identical configuration.

The rear wheel receiving portion comprises a lateral element 58, an outer element 60 and a connection element 62. The receiving portion is made of a flat cardboard sheet which has been cut to size, as shown in FIG. 4. For packaging the bicycle (FIG. 1), the lateral element 58 of the two rear wheel receiving portions 52,54 is in abutment on an inner side 64 of a side wall 66 of the outer box 10. In this arrangement, a width A (FIG. 3) corresponds to the inner width of box 10, resulting in a lateral guidance and respectively fixation.

In the packaged state, the outer element 60 of the lower rear wheel receiving portion 52 is in abutment on an inner side of bottom 50. In a corresponding manner, the outer element 60 of the upper rear wheel receiving portion 54 is in abutment on an inner side of a cover 68. When seen in frontal view (FIG. 3), the rear wheel receiving portions 52,54 are formed with a slot 70. In the packaged state, said slot has the rear wheel 14 arranged in it. In addition to slot 70, a recess 72 is provided in the connection element 62. In the packaged state, said recess has the small-parts container 55 arranged in it. The dimensions of recess 72 are selected to be somewhat smaller than the width of the small-parts container 55. For stabilization of the position of the small-parts container 55, a flap 74 is provided which is pivotable around a kinking edge 76 and thus exerts a certain force onto the small-parts container towards the right-hand side in FIG. 2. Thereby, the position of the small-parts container 55 is defined.

In the illustrated exemplary embodiment, the slots 70 for receiving the rear wheel 14 are produced by first punching out two semicircular openings 78 (FIG. 4). The two openings are connected to each other by a cut 80 in the flat cardboard sheet. Thereby, it is possible to fold out flaps 84 along the kinking edges 82. At the same time, said flaps 84 will fix the wheel 14 in both slots 70.

For producing the rear wheel receiving portion 52,54 which in lateral view is substantially triangular (FIG. 2), a plane cardboard piece will be cut into shape as shown in FIG. 4. Apart from the above described recesses, cuts and kinking edges, the cardboard element comprises three further kinking edges 86, 87, 88. Further, at a front side, flaps 90 are arranged which are adapted to be inserted into recesses 91. By a corresponding kinking deformation on the edges 86, 87, 88 and insertion of the flaps 90 into the recesses 91, the two rear wheel receiving portions, which in the illustrated exemplary embodiment are identical, will be produced.

An independent disclosure, which however is preferably combined with the disclosure described with reference to FIGS. 1-4, resides in the provision of a stem receiving portion 92. For packaging the bicycle, the stem receiving portion 92 is mounted on the stem 22 preferably from above, as shown in FIG. 1. The stem receiving portion comprises a positioning element 94 and a holding element 96 which in the illustrated exemplary embodiment is connected to the positioning element 94. The positioning element 94 is preferably made of cardboard, and with preference is made of one or a plurality of layers of rectangular flat cardboard. On an underside 98 of the positioning element 94, the holding element 96 is arranged. Fixation herein is preferably realized by bonding, and the holding element 96 is preferably again an element made of cardboard. Preferably, the holding element is a box-like structure which is open at its underside so that it can be pushed over the stem 22 as shown in FIG. 1. Thus, in the illustrated embodiment, the box-shaped holding element comprises four side walls 100 which, with the stem receiving portion 92 arranged internally of outer box 10, are arranged laterally next to the stem 22 and surround the latter. Further, in the illustrated embodiment, the box-shaped holding element comprises a cover element 102, likewise made of cardboard. The latter is connected to the underside 98 of positioning element 94 e.g. by bonding. Thus, the holding element 96 is configured according to the bottom view shown in FIG. 5 while having a free opening 104.

In case of a positioning element 94 of a rectangular shape, the holding element 96, as shown in FIG. 5, is arranged in oblique orientation. This oblique arrangement corresponds to the position of the stem which, for packaging, has been turned rearwards relative to the conventional moving direction of the bicycle (FIG. 1).

In the packaged state, a support element 106 is arranged opposite to the stem receiving portion 92. In the illustrated embodiment, support element 106 consists of a plurality of cardboard layers and rests on the inner side of bottom 50 of outer box 10. In the upper layers of support element 106, two recesses 108 are provided. In said recesses 108, respectively one end of a fork leg 110 is arranged.

It is particularly preferred that the stem receiving portion 92 has a width A corresponding to the clear width of the outer container, thereby ensuring a lateral guidance. In correspondence thereto, it is preferred that the support element 106 has a corresponding width A.

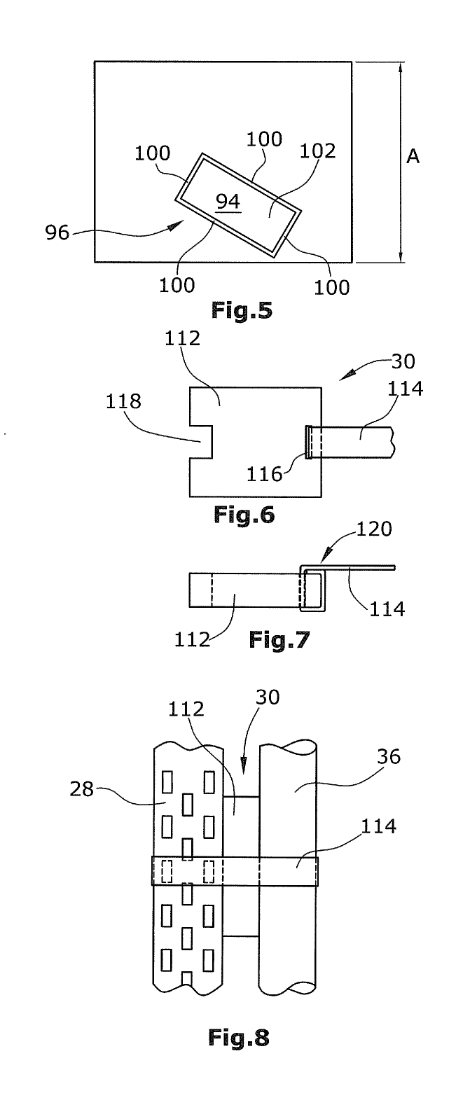

Further, it is preferred that fixing elements 30 are provided on the frame for fastening e.g. the front wheel 28. These fixing elements comprise a protective body 112 (FIG. 6) having an e.g. substantially parallelepipedic shape. Protective body 112 is again made of foamed material. In the illustrated embodiment, protective body 112 has a band-shaped connection element 114 connected to it. For this purpose, protective body 112 comprises a slot 116. Through this slot, as evident particularly from FIG. 7, one end of the connection element 114 is passed. Since, according to a preferred embodiment, the outer sides of connection element 114 comprise a hook-and-loop fastener or the like, the connection element 114 can be formed as a strap as shown in FIG. 7 and thus can be connected to protective body 112 in a simple manner.

In the illustrated embodiment, protective body 112 comprises a recess 118. The recess 118 is arranged opposite to slot 116 and respectively is arranged in the winding or fastening direction of the band-shaped connection element 114. Thus, when fastening the connection element 114, the latter can be inserted into recess 118, and then the free end of connection element 114 will be connected to the end 120 attached to protective body 112 or will be connected in this area of band 114.

FIG. 8 schematically illustrates a connection of the front wheel to a frame with the aid of the fixing element shown in FIGS. 6 and 7. Herein, this can be e.g. the fixation of the front wheel 28 to the upper tube 36. For fixation, protective body 112 will be arranged between front wheel 28 and top tube 36. Then, the band-shaped connection element 114 will be guided both over front wheel 28 and top tube 36 wherein, for fixation, the free end of connection element 114 will be connected to the end 120 arranged on the protective body. Particularly because of the connection of the connection element to protective body 112 and because of the provision of hook-and-loop fasteners, fixation and release can be carried out in a simple manner.

For packaging the bicycle, there will first be performed a pre-assembly process so that the rear wheel 14, the fork 110 and the stem 22 will have been mounted. Also all of the components provided on handlebar 24 inclusive of switching levers, handles etc. have been mounted, inclusive of connection elements such as Bowden cables, the hydraulic conduit and the like. The bicycle handlebar 24 is merely not connected to the stem 22. For packaging, in the illustrated embodiment, the bicycle fork will be rotated so that the stem 22 is caused to face toward the rear. Then, the bicycle saddle 34 will be fixed, e.g. in the area of a fork bridge of fork 20, by provision of a fixing element 30. The bicycle saddle could also be fixed to the saddle tube 32 or to other parts of the frame 12.

The bicycle handlebar 24 will be fixed, again with the aid of fixing elements 30, e.g. to the top tube 36 or, optionally, additionally to one of the two fork legs.

Further, the front wheel 28 will be fixed, in the illustrated embodiment with the aid of two fixing elements 30, to the top tube 36 on the one hand and to the seat stay 40 on the other hand. Fixation will again be carried out with the aid of fixing elements 30. Fixation will be performed in such a manner that a support point 46 of front wheel 28 by which the front wheel is supported on the bottom 50 of outer box 10, is arranged lower than a bottom side of chain ring 48. Thereby, damage to chain ring 48 during transport will be avoided.

After fixation of front wheel 28, handlebar 24 and saddle 34, the bicycle together with these components will constitute one unit. This will allow for easy handling. The bicycle pre-packaged in this manner can be placed into the outer box e.g. from above. Rotational displacement, jamming and the like will be avoided. Further, it will not be necessary to install individual bicycle components after the bicycle frame has already been arranged within outer box 10. Consequently, for instance, it is avoided that the bicycle frame could happen to be scratched by subsequent placement of a wheel in the outer box. For placement of the pre-packaged bicycle in outer box 10, the latter has been provided with the rear wheel receiving portion 52 and the support element 106. The rear wheel 14 will be inserted into the slot 70 of the lower rear wheel receiving portion 52. The ends 110 of the bicycle fork 120 will be plugged into the recesses 108 of support element 106. Then, the small-parts container 55 will be placed in the recess 72 of the lower rear wheel receiving portion 52 and, subsequently, the upper rear wheel receiving portion 54 will be arranged in such a manner that the rear wheel 14 will again be placed in slot 70 and the small-parts container 55 will again be placed in recess 72.

Further, the stem receiving portion 92 will be arranged in a manner causing the stem 22 to be placed within holding element 96. Since the widths A of the two rear wheel receiving portions 52,54 as well as of the stem receiving portion 92 and of the support element 106 correspond to the inner clear width of outer box 10, the bicycle is secured against sliding out of position laterally. Further, the arrangement of the rear wheel 14 in the slots 70 and the arrangement of the support ends 110 in the recesses 108 is realized in such a manner preventing the bicycle from sliding out of position in the longitudinal direction of outer box 10. Thus, the outer box 10 merely has to be closed and can be shipped via parcel delivery services.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. It is therefore intended to include within the disclosure all such variations and modifications as fall within the scope of the appended claims and equivalents thereof.

What is claimed is:

1. A bicycle transport container, particularly a bicycle transport box made of cardboard, comprising:
an outer container, particularly an outer cardboard box, for receiving a bicycle with mounted rear wheel,
a lower rear wheel receiving portion,
an upper rear wheel receiving portion which in the packed state is arranged opposite to the lower rear wheel receiving portion, and
a stabilizing element arranged at least partially between the lower rear wheel receiving portion and the upper rear wheel receiving portion and formed as a small-parts container.

2. The bicycle transport container according to claim 1, wherein the lower and/or the upper rear wheel receiving portion comprises a lateral element which in the packed state is in abutment, preferably in face-to-face abutment, on an inner side of a side wall of the outer container and preferably has the width of the inner side.

3. The bicycle transport container according to claim 1, wherein the lower and/or the upper rear wheel receiving portion comprise an outer element which in the packed state is in abutment, preferably in face-to-face abutment, on an inner side of a bottom and respectively of a cover of the outer container and preferably has the same width as the bottom and respectively the cover.

4. The bicycle transport container according to claim 3, wherein the lateral element is arranged at a right angle relative to the outer element.

5. The bicycle transport container according to claim 3, wherein the lateral element is connected to the outer element via a connection element wherein, when seen in lateral view, the lateral element, the outer element and the connection element are preferably substantially of a triangular configuration.

6. The bicycle transport container according to claim 5, wherein the connection element comprises a slot for receiving a part of the rear wheel.

7. The bicycle transport container according to claim 3, wherein the lateral element and/or the outer element and/or the connection element are made of cardboard, particularly flat cardboard, wherein the lateral element, the outer element and the connection element are preferably made of a one-pieced cardboard element.

8. The bicycle transport container according to claim 1, wherein the lower and the upper rear wheel receiving portion are substantially formed to have identical configurations.

9. The bicycle transport container according to claim 1, wherein the lower and/or the upper rear wheel receiving portion, particularly the connection element of the rear wheel receiving portion, comprise a recess for receiving a part of the stabilizing element, particularly of the small-parts container.

10. A bicycle transport container, particularly a bicycle transport box made of cardboard, comprising:
an outer container, particularly an outer cardboard box, for receiving a bicycle with mounted bicycle fork and mounted stem, and
a stem receiving portion holding the stem in its position in the outer container.

11. The bicycle transport container according to claim 10, wherein the stem receiving portion comprises a holding element at least partially gripping around the stem.

12. The bicycle transport container according to claim 11, wherein the holding element comprises holding members, preferably made of cardboard, which in the packaged state are arranged laterally adjacent to the stem.

13. The bicycle transport container according to claim 12, wherein a plurality of holding members, preferably four holding members, are provided which surround the stem on all sides.

14. The bicycle transport container according to claim 10, wherein the stem receiving portion comprises a positioning element for positional definition in the outer container, said positioning element being preferably connected to the holding element.

15. The bicycle transport container according to claim 14, wherein the positioning element has a width substantially corresponding to the clear width of the outer container.

16. The bicycle transport container according to claim 10, wherein a support element for a mounted front-wheel fork is provided on the bottom of the outer box, said support element being preferably made of cardboard.

17. The bicycle transport container according to claim 16, wherein the support element comprises two recesses for respectively one fork leg end.

18. A bicycle fixing element for fixation of bicycle components for transport, comprising:
a protective body for arrangement between the bicycle components which are to be fixed; and
a connection element, preferably connected to the protective body, for connecting the protective body to the bicycle components which are to be fixed.

19. The bicycle fixing element according to claim 18, wherein the protective body comprises an elastomeric body.

20. The bicycle fixing element according to claim 18, wherein the connection element is band-shaped and/or comprises a hook-and-loop fastener.

21. The bicycle fixing element according to claim 18, wherein the protective body comprises a slot having the connection element extending through it.

22. The bicycle fixing element according to claim 18, wherein the protective body comprises a laterally open recess provided to define the position of the connection element during the fixing of the bicycle components.

23. A bicycle prepared for packaging in a bicycle transport container according to either claim 1 or 10, wherein a front wheel of said bicycle is fixed to a bicycle frame by means of a bicycle fixing element comprising:
a protective body for arrangement between the bicycle components which are to be fixed; and
a connection element, preferably connected to the protective body, for connecting the protective body to the bicycle components which are to be fixed.

24. The bicycle prepared for packaging according to claim 23, wherein a bicycle handlebar is fixed to the bicycle frame by means of the bicycle fixing element.

25. The bicycle prepared for packaging according to claim 23, wherein a rear wheel is arranged in its mounted state.

26. The bicycle prepared for packaging according to claim 23, wherein a fork or a stem is arranged in its mounted state.

27. The bicycle prepared for packaging according to claim 23, wherein a saddle is fixed to a fork and/or to the bicycle frame by means of said bicycle fixing element.

28. The bicycle transport container according to either claim 1 or 10, together with a bicycle prepared for packaging, wherein a front wheel of said bicycle is fixed to a bicycle frame by means of a bicycle fixing element comprising:
a protective body for arrangement between the bicycle components which are to be fixed; and
a connection element, preferably connected to the protective body, for connecting the protective body to the bicycle components which are to be fixed.
